(19) United States
(12) Patent Application Publication
(10) Pub. No.: US 2022/0022435 A1
(43) Pub. Date: Jan. 27, 2022

(54) Tubular Bait Retrieval Apparatuses and Methods of Using the Same

(71) Applicants: Lawrence Palmer, McHenry, IL (US); Martin Palmer, Johnsburg, IL (US); Jon Palmer, St. Charles, IL (US)

(72) Inventors: Lawrence Palmer, McHenry, IL (US); Martin Palmer, Johnsburg, IL (US); Jon Palmer, St. Charles, IL (US)

(21) Appl. No.: 16/936,671

(22) Filed: Jul. 23, 2020

(51) Int. Cl. A01K 69/06; A01M 23/02

(52) U.S. Cl. CPC A01K 69/06; A01M 23/02

(57) ABSTRACT

Tubular bait fish retrieval apparatuses comprise a generally cylindrically-shaped or prism-shaped body comprising an opening on a first end thereof configured to allow passage of a bait fish therethrough, and a generally closed second end having at least one aperture configured to fill the body with water when disposed within the water and for draining the water from the body when removed from the water. Methods of using the same are further provided.

### TECHNICAL FIELD

The present invention relates to tubular bait fish retrieval apparatuses. Specifically, the tubular bait fish retrieval apparatuses comprise a generally cylindrically-shaped or prism-shaped body comprising an opening on a first end thereof configured to allow passage of a bait fish therethrough, and a generally closed second end having at least one aperture configured to fill the body with water when disposed within the water and for draining the water from the body when removed from the water. Methods of using the same are further provided.

### BACKGROUND

Individuals often use live bait when fishing. Indeed, it is common to utilize bait fish, such as carp, minnows, anchovies, and other like bait fish to attract other fish. Indeed, a bait fish is typically disposed on a hook that is then dropped into a body of water. As the bait fish wriggles on the hook, the sight and smell thereof may attract larger fish that may want to ingest the bait fish. When ingested, the hook then engages with the larger fish, allowing the individual to catch the same.

The use of bait fish is limited because bait fish must be kept alive prior to use as bait. Specifically, it is common to have a number of bait fish within a bucket or tub of water. When an individual wishes to use a bait fish as bait, he or she must typically reach into the water to try to get one of the bait fish.

It is often difficult for an individual to catch a bait fish when needed. Oftentimes, a user places his or her hand in the bucket or tub of water and the bait fish, sensing danger, often swim away from the user's hand. Moreover, the bait fish are often slippery and difficult to hold onto when grasped by an individual. In many cases, an individual, in attempting to catch and hold onto a bait fish, may damage the bait fish, causing the bait fish to die on the hook too soon, decreasing the effectiveness of the bait fish in attracting larger fish.

Moreover, individuals are often uncomfortable placing their hands in a bucket or tub of water to catch a bait fish. Indeed, some bait fish may require relatively cold water temperature to maintain health, and placing hands in relatively cold water can be uncomfortable or dangerous to individuals.

In addition, individuals may not wish to directly handle a bait fish. In addition, individuals may introduce diseases or chemicals into the bucket or tub of water that may impact the health and lives of the bait fish contained therein. This may cause the bait fish to expire prematurely before being used as bait fish.

A need, therefore, exists for an improved apparatus for handling bait fish. Specifically, a need exists for an apparatus to easily retrieve live bait fish from a bucket or tub of water. More specifically, a need exists for an apparatus that minimizes contact between an individual's hand, the bucket or tub of water, and the bait fish itself.

Moreover, a need exists for a tubular bait fish retrieval apparatus. Specifically, a need exists for a tubular bait fish retrieval apparatus that is configured to easily catch and hold a bait fish therein. More specifically, a need exists for a tubular bait fish retrieval apparatus that allows for the retrieval and removal of bait fish from a bucket or tub of water without requiring excess handling of the bait fish by the individual.

In addition, a need exists for a tubular bait fish retrieval apparatus that provides for nearly instantaneous retrieval of bait fish when desired. A need further exists for a tubular bait fish retrieval apparatus that prevents or minimizes individual's contact with a bucket or tub of water, thereby minimizing transfer of diseases and/or chemicals to the live bait fish. Still further, a need exists for a tubular bait fish retrieval apparatus that minimizes contact between an individual and a bait fish, thereby protecting the health and life of the bait fish until desired to be used as bait.

### SUMMARY OF THE INVENTION

The present invention relates to tubular bait fish retrieval apparatuses. Specifically, the tubular bait fish retrieval apparatuses comprise a generally cylindrically-shaped or prism-shaped body comprising an opening on a first end thereof configured to allow passage of a bait fish therethrough, and a generally closed second end having at least one aperture configured to fill the body with water when disposed within the water and for draining the water from the body when removed from the water. Methods of using the same are further provided.

To this end, in an embodiment of the present invention, a tubular bait fish retrieval apparatus is provided. The tubular bait fish retrieval apparatus comprises a tubular body having a first end, a second end, a length therebetween, and an internal space between the first end and the second end; an opening at the first end thereof configured to allow passage of a live bait fish, and at least one hole at the second end thereof configured to block passage of a live bait fish; and a retrieval line attached to the body configured to retrieve the tubular body from a body of water after a live bait fish swims into the tubular body.

In an embodiment, the retrieval line is connected to the tubular body with a connector selected from the group consisting of a ring and a clip.

In an embodiment, the tubular bait fish retrieval apparatus further comprises a screen at the second end of the tubular body.

In an embodiment, the tubular body is cylindrical.

In an embodiment, the tubular body is prism-shaped.

In an embodiment, the tubular body comprises a material configured to allow the tubular body to be buoyant and float above a bottom of a body of water.

In an embodiment, the tubular body is made from a material configured to allow the tubular body to be buoyant and float above a bottom of a body of water.

In an embodiment, the material is a foam material.

In an embodiment, the tubular bait fish retrieval apparatus further comprises at least one fin extending from the tubular body.

In an embodiment, the tubular bait fish retrieval apparatus further comprises a signaling element associated with the tubular body, wherein the signaling element is configured to signal that a bait fish is disposed within the tubular body.

In an embodiment, the tubular bait fish retrieval apparatus further comprises a gas canister within the tubular body, wherein the gas canister is configured to release a gas within the tubular body when a fish swims into the tubular body.

In an alternate embodiment of the present invention, a method of retrieving a bait fish from a body of water is provided. The method comprises the steps of providing a tubular bait fish retrieval apparatus comprising a tubular body having a first end, a second end, a length therebetween, and an internal space between the first end and the second end; an opening at the first end thereof configured to allow passage of a live bait fish, and at least one hole at the second end thereof comprising a size and shape configured to allow passage of water but to block passage of a live bait fish; and a retrieval line attached to the body configured to retrieve the tubular body from a body of water after a live bait fish swims into the tubular body; disposing the tubular bait fish retrieval apparatus into a body of water; waiting for a fish to swim into the tubular bait fish retrieval apparatus; retrieving the tubular bait fish retrieval apparatus and the bait fish from the body of water with the line; and retrieving the bait fish from the tubular bait fish retrieval apparatus.

In an embodiment, the retrieval line is connected to the tubular body with a connector selected from the group consisting of a ring and a clip.

In an embodiment, the method further comprises the step of draining the water from the tubular body through the at least one hole in the second end of the tubular body.

In an embodiment, the tubular body further comprises a screen at the second end thereof, and further comprises the step of draining the water from the tubular body through the screen at the second end of the tubular body.

In an embodiment, the tubular body comprises a material configured to allow the tubular body to be buoyant and float above a bottom of the body of water, and further comprises the step of disposing the tubular body at a location above the bottom of the body of water.

In an embodiment, the tubular body is made from a material configured to allow the tubular body to be buoyant and float above a bottom of the body of water, and further comprises the step of disposing the tubular body at a location above the bottom of the body of water.

In an embodiment, the tubular bait fish retrieval apparatus further comprises at least one fin extending from the tubular body, and further comprises the steps of disposing the tubular body in the body of water wherein the body of water is moving; and stabilizing the tubular body in the body of water with the fin.

In an embodiment, the tubular bait fish retrieval apparatus further comprises a signaling element associated with the tubular body, and further comprises the step of: signaling that a bait fish is disposed within the tubular body with the signaling element.

In an embodiment, the tubular bait fish retrieval apparatus further comprises a gas canister within the tubular body, and further comprises the step of: releasing a gas from the gas canister within the tubular body when a fish swims into the tubular body to cause the tubular bait fish retrieval apparatus to float.

It is, therefore, an advantage and objective of the present invention to provide an improved apparatus for handling bait fish.

Specifically, it is an advantage and objective of the present invention to provide an apparatus to easily retrieve live bait fish from a bucket or tub of water.

More specifically, it is an advantage and objective of the present invention to provide an apparatus that minimizes contact between an individual's hand, the bucket or tub of water, and the bait fish itself.

Moreover, it is an advantage and objective of the present invention to provide a tubular bait fish retrieval apparatus.

Specifically, it is an advantage and objective of the present invention to provide a tubular bait fish retrieval apparatus that is configured to easily catch and hold a bait fish therein.

More specifically, it is an advantage and objective of the present invention to provide a tubular bait fish retrieval apparatus that allows for the retrieval and removal of bait fish from a bucket or tub of water without requiring excess handling of the bait fish by the individual.

In addition, it is an advantage and objective of the present invention to provide a tubular bait fish retrieval apparatus that provides for nearly instantaneous retrieval of bait fish when desired.

Further, it is an advantage and objective of the present invention to provide a tubular bait fish retrieval apparatus that prevents or minimizes individual's contact with a bucket or tub of water, thereby minimizing transfer of diseases and/or chemicals to the live bait fish.

Still further, it is an advantage and objective of the present invention to provide a tubular bait fish retrieval apparatus that minimizes contact between an individual and a bait fish, thereby protecting the health and life of the bait fish until desired to be used as bait.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a side view of a bucket or tub comprising an amount of water, a plurality of fish, and a tubular bait fish retrieval apparatus disposed at a bottom of the bucket or tub in an embodiment of the present invention.

FIG. 2 illustrates a side view of a bait fish retrieval apparatus having a bait fish therein in an embodiment of the present invention.

### DETAILED DESCRIPTION OF THE PRESENTLY PREFERRED EMBODIMENTS

The present invention relates to tubular bait fish retrieval apparatuses. Specifically, the tubular bait fish retrieval apparatuses comprise a generally cylindrically-shaped or prism-shaped body comprising an opening on a first end thereof configured to allow passage of a bait fish therethrough, and a generally closed second end having at least one aperture configured to fill the body with water when disposed within the water and for draining the water from the body when removed from the water. Methods of using the same are further provided.

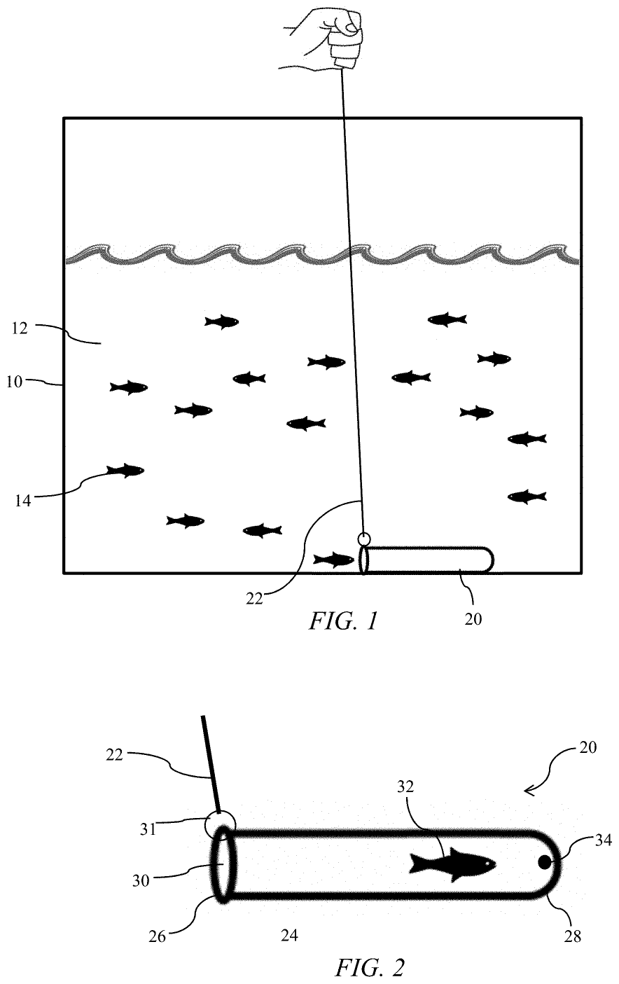

Referring now to FIG. 1, a bucket or tub 10 comprises an amount of water 12. Within the bucket or tube 10 may be a plurality of live bait fish 14 for use as bait by an individual when desired. Disposed on a bottom of the bucket or tubel0 may be a tubular bait fish retrieval apparatus 20 of the present invention, as described in more detail below.

As noted above, it may be difficult to retrieve a live bait fish from a bucket or tub or other quantity of water when desired for use as bait when fishing. The tubular bait fish retrieval apparatus 20 of the present invention may provide a quick, easy and efficient way to capture and retrieve a live bait fish for use when fishing to attract a larger fish. In an embodiment of the present invention, the tubular bait fish retrieval apparatus may be disposed within the amount of water 12 and may be used to capture and retrieve a life bait fish.

More specifically, live bait fish typically desire to be in enclosed, dark spaces. Typically, an enclosed dark space represents a safe space for the bait fish. Thus, a live bait fish would naturally move themselves into a perceived safe space if possible. The tubular bait fish retrieval apparatus 20 of the present invention may provide such a safe space for a live bait fish.

When disposed within the amount of water 12, the tubular bait fish retrieval apparatus 20 is configured to allow a bait fish to swim thereinto. Once within the tubular bait fish retrieval apparatus 20, a string or line 22 or other retrieval means, may be used to pull the tubular bait fish retrieval apparatus 20 from the water 12, thereby removing the live bait fish from the water quickly, easily and efficiently, without the user placing his or her hands within the water 12. It has been found that live bait fish naturally swim within the tubular bait fish retrieval apparatus 12, and effectively allows an individual to easily retrieve the live bait fish from the bucket or tube 10.

FIG. 2 illustrates a close-up view of the tubular bait fish retrieval apparatus 20 in an embodiment of the present invention. The tubular bait fish retrieval apparatus 20 comprises a body 24 having a length, and an open end 26 and a closed end 28. The open end 26 comprises an opening 30 that is sized, shaped and/or otherwise configured to allow passage of a live bait fish 32 into the body 24. Thus, a live bait fish, sensing a secure, safe space within the body 24, may swim through the opening 30 and into the interior space of the body 24 where it may remain. Because the live bait fish is likely unable to swim backward, it will find itself trapped within the body 24 without means of escape.

The body 24 is shown as a cylindrical tube, which may have a circular or oval-shaped cross-section. In other embodiments, the body 24 may be prism-shaped, such as square, triangular, or rectangular prism-shaped, or any other prism-shaped, that provides the functionality as described herein. Although the body 24 is described with the specific shapes noted above, it should be further noted that the body 24 may be any shape apparent to one of ordinary skill in the art.

The closed end 28 may comprise one or more holes 34 that allow for the passage of water therethrough, but not large enough to allow the passage of the live bait fish 32 that may be contained therein. Thus, when the tubular bait fish retrieval apparatus 20 is dropped into the water 12, the hole 34 and the opening 30 allows the body 24 to fill with water so that the tubular bait fish retrieval apparatus can quickly settle into the water. Likewise, when removed from the water 12, the hole 34 allows the water within the body 24 to drain therefrom, leaving only the live bait fish 32 therein. When retrieved with the live bait fish 32 therein, and after the water therein is drained, the user may tip the closed end 28 up to slide the live bait fish 32 out of the body 24. Thus, the user may easily obtain the live bait fish from the bucket or tub 10.

The open end 26 of the body 24 may have a ring or clip 31 disposed within an aperture near the opening 30. The ring or clip may allow the line 22 to be connected thereto so that a user may easily retrieve the tubular bait fish retrieval apparatus 20 from within the water 12. Alternately, the line 22 may be connected directly to the body 24 within an aperture or other like feature.

Although FIG. 1 illustrates the tubular bait fish retrieval apparatus 20 resting on the bottom of the bucket or tub 10, it should be noted that it may be preferable to have the tubular bait fish retrieval apparatus 20 have an amount of buoyancy so that the tubular bait fish retrieval apparatus 20 rests in a position at a point between the bottom of the bucket or tub 10 and water level within the bucket or tub 10. Specifically, the tubular bait fish retrieval apparatus may be made from or have an added material, such as a foam or other like material, that prevents complete sinking of the same within the bucket or tub 10. The material may be on the apparatus 20 or otherwise disposed within the apparatus 20 to provide a neutral buoyancy at a desired position within the bucket or tub 10. Thus, if the live bait fish do not like to swim near the bottom of the bucket or tub 10, but at some other level within the bucket or tub 10.

In addition, the closed end 28 of the body 24 may not be completely closed, as shown in FIG. 2, but may instead contain a screen or another element that allows water to flow therethrough, but prevents the live bait fish 32 from escaping.

In another alternate embodiment of the present invention, the body 24 of the tubular bait fish retrieval apparatus 20 may have fins or other elements that stabilize the body 24, especially if the body 24 is within a body of water having a current therein. For example, live bait fish may be contained within a live well on a boat, having constantly circulating water therein. Because of the movement of the water therein, the body 24 may not remain still, making it difficult for a live bait fish to swim therein. Thus, fins or other stabilizing elements on the body 24 may aid in stabilizing the body 24 within the moving water.

In yet another embodiment of the present invention, the tubular bait fish retrieval apparatus 20 may have a mechanism that signals that a live bait fish has swum into the body 24 thereof. Specifically, the live bait fish 32 may trigger or trip a signal, such as a flag, a lever, or other indicator indicating its presence within the body 24. The signal may be electronic, such as a light or a symbol that may appear on the body 24 when a fish is in the body 24. In an alternate embodiment, a mechanism within the body 24 may be configured to cause the body to float to the surface of the bucket or tub 10 when a live bait fish swims into the body. Specifically, after a fish swims into the body 24, a trigger may cause a gas canister to expand in one or more spaces within the body 24, causing the tubular bait fish retrieval apparatus 20 to gain a positive buoyancy, thereby triggering the tubular bait fish retrieval apparatus 20 to float to the surface, allowing a user to easily grasp it from the water.

The tubular bait fish retrieval apparatus 20, as described herein in its various embodiments, may be made from any material useful to provide the functionality described herein. Preferably, the body 24 may be made from metal, plastic, wood, composite materials, or any other materials that allow for the functionality described herein. Of course, the material is preferably safe for the environment and will not damage the live bait fish or ecosystems in which the apparatus 20 may be utilized.

Moreover, the tubular bait fish retrieval apparatus 20 may also be used by aquarium owners that may need to retrieve live fish from the aquarium, such as when the aquarium cleaning is desired. Indeed, the tubular bait fish retrieval apparatus 20 may be used in any application where a fish is required to be retrieved that may otherwise be difficult to catch within a body of water.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are non-limiting, and it should be noted that claim limitations presented herein are not meant to describe the invention as a whole. Moreover, the invention illustratively disclosed herein suitably may be practiced in the absence of any element which is not specifically disclosed herein.

We claim:

1. A tubular bait fish retrieval apparatus comprising:
a tubular body having a first end, a second end, a length therebetween, and an internal space between the first end and the second end;
an opening at the first end thereof configured to allow passage of a live bait fish, and at least one hole at the second end thereof comprising a size and shape configured to allow passage of water but to block passage of a live bait fish; and
a retrieval line attached to the body configured to retrieve the tubular body from a body of water after a live bait fish swims into the tubular body.

2. The tubular bait fish retrieval apparatus of claim 1 wherein the retrieval line is connected to the tubular body with a connector selected from the group consisting of a ring and a clip.

3. The tubular bait fish retrieval apparatus of claim 1 further comprising:
a screen at the second end of the tubular body.

4. The tubular bait fish retrieval apparatus of claim 1 wherein the tubular body is cylindrical.

5. The tubular bait fish retrieval apparatus of claim 1 wherein the tubular body is prism-shaped.

6. The tubular bait fish retrieval apparatus of claim 1 wherein the tubular body comprises a material configured to allow the tubular body to be buoyant and float above a bottom of a body of water.

7. The tubular bait fish retrieval apparatus of claim 1 wherein the tubular body is made from a material configured to allow the tubular body to be buoyant and float above a bottom of a body of water.

8. The tubular bait fish retrieval apparatus of claim 7 wherein the material is a foam material.

9. The tubular bait fish retrieval apparatus of claim 1 further comprising:
at least one fin extending from the tubular body.

10. The tubular bait fish retrieval apparatus of claim 1 further comprising:
a signaling element associated with the tubular body, wherein the signaling element is configured to signal that a bait fish is disposed within the tubular body.

11. The tubular bait fish retrieval apparatus of claim 1 further comprising:
a gas canister within the tubular body, wherein the gas canister is configured to release a gas within the tubular body when a fish swims into the tubular body.

12. A method of retrieving a bait fish from a body of water comprising the steps of:
providing a tubular bait fish retrieval apparatus comprising a tubular body having a first end, a second end, a length therebetween, and an internal space between the first end and the second end; an opening at the first end thereof configured to allow passage of a live bait fish, and at least one hole at the second end thereof comprising a size and shape configured to allow passage of water but to block passage of a live bait fish; and a retrieval line attached to the body configured to retrieve the tubular body from a body of water after a live bait fish swims into the tubular body;
disposing the tubular bait fish retrieval apparatus into a body of water;
waiting for a fish to swim into the tubular bait fish retrieval apparatus;
retrieving the tubular bait fish retrieval apparatus and the bait fish from the body of water with the line; and
retrieving the bait fish from the tubular bait fish retrieval apparatus.

13. The method of claim 12 wherein the retrieval line is connected to the tubular body with a connector selected from the group consisting of a ring and a clip.

14. The method of claim 12 further comprising the step of:
draining the water from the tubular body through the at least one hole in the second end of the tubular body.

15. The method of claim 12 wherein the tubular body further comprises a screen at the second end thereof, and further comprising the step of:
draining the water from the tubular body through the screen at the second end of the tubular body.

16. The method of claim 12 wherein the tubular body comprises a material configured to allow the tubular body to be buoyant and float above a bottom of the body of water, further comprising the step of:
disposing the tubular body at a location above the bottom of the body of water.

17. The method of claim 12 wherein the tubular body is made from a material configured to allow the tubular body to be buoyant and float above a bottom of the body of water, further comprising the step of:
disposing the tubular body at a location above the bottom of the body of water.

18. The method of claim 12 wherein the tubular bait fish retrieval apparatus further comprises at least one fin extending from the tubular body, further comprising the steps of:
disposing the tubular body in the body of water wherein the body of water is moving; and
stabilizing the tubular body in the body of water with the fin.

19. The method of claim 12 wherein the tubular bait fish retrieval apparatus further comprises a signaling element associated with the tubular body, further comprising the step of:
signaling that a bait fish is disposed within the tubular body with the signaling element.

20. The method of claim 12 wherein the tubular bait fish retrieval apparatus further comprises a gas canister within the tubular body, further comprising the step of:
releasing a gas from the gas canister within the tubular body when a fish swims into the tubular body to cause the tubular bait fish retrieval apparatus to float.
